(19) United States
(12) Patent Application Publication
(10) Pub. No.: US 2024/0343959 A1
(43) Pub. Date: Oct. 17, 2024

(54) HOT MELT ADHESIVE

(71) Applicant: HENKEL AG &CO. KGaA, Duesseldorf (DE)

(72) Inventor: Shigekazu Saito, Osaka (JP)

(21) Appl. No.: 18/672,147

(22) Filed: May 23, 2024

Related U.S. Application Data
(63) Continuation of application No. PCT/JP2022/043274, filed on Nov. 24, 2022.

(30) Foreign Application Priority Data
Nov. 25, 2021 (JP) 2021-191325

(51) Int. Cl. C09J 193/04; C09J 193/00; C09J 195/00

(52) U.S. Cl. CPC C09J 193/04; C09J 193/00; C09J 195/00

(57) ABSTRACT

To provide a hot melt adhesive having excellent coatability and adhesiveness to a member of a disposable product, excellent storage stability, and both having high natural resin use ratio and low odor; and a disposable product obtained by using the hot melt adhesive. A hot melt adhesive comprising (A) a thermoplastic block copolymer which is a copolymer of vinyl-type aromatic hydrocarbons and conjugated diene compounds, (B) a tackifying resin and (C) a wax, wherein the tackifying resin (B) comprises (B1) a natural resin having an acid value of 20 mg KOH/g or less.

### CROSS-REFERENCE TO RELATED APPLICATION

This application claims benefit under Article 4 of the Paris Convention based on Japanese Patent Application No. 2021-191325 filed in Japan on Nov. 25, 2021, incorporated herein by reference in its entirely.

### TECHNICAL FIELD

The present invention relates to a hot melt adhesive, and more particularly to a hot melt adhesive for use in the field of disposable products such as disposable diapers and napkins.

### BACKGROUND ART

Hot melt adhesives are used in disposable products such as disposable diapers and napkins. Hot melt adhesives are applied to substrates such as nonwoven fabric, tissue and polyethylene film, and a plurality of these substrates are combined to produce a disposable product.

Examples of the hot melt adhesive may include generally synthetic rubber based hot melt adhesives composed as a main component of thermoplastic block copolymers, and olefin based hot melt adhesives typified by ethylene/propylene/butene copolymers. Considering coatability, cohesive force and the like, synthetic rubber-based hot melt adhesives may be used rather than olefin-based adhesives.

Generally, hot melt adhesives include a base polymer and a plasticizer. It has been studied that the amount of the base polymer is reduced, and the amount of the plasticizer is increased to decrease viscosity and to improve coating suitability of the hot melt adhesives.

However, as the plasticizer content increases, the cohesive force of the hot melt adhesive decreases and the softening point also decreases. Hot melt adhesives with low cohesive force easily cause cohesive failure, resulting in poor adhesiveness to a member of the disposable product (e.g., polyethylene and polypropylene films). Hot melt adhesives having a softening point of 30° C. or less melt in summertime, fail to retain their shape even when stored in a solidified state, for example, in a warehouse, and causes a cold flow phenomenon, resulting in insufficient storage stability.

Furthermore, in recent years, it has been recommended that the use ratio of natural resins such as rosin esters in hot melt adhesives is increased from the viewpoint of that the load imposed on the environment is lightened. For example, Patent Documents 1 and 2 disclose hot melt adhesives containing styrene block polymers and rosin esters.

Patent document 1 discloses a hot melt adhesive containing a styrene-based thermoplastic elastomer, a process oil, and an acid-modified rosin ([claim 1], [0023], [0024], and Table 1). Patent document 2 discloses a hot melt adhesive containing a partially hydrogenated styrene block copolymer and a rosin ester ([claim 1], [0071], [0083], and Table 1).

On the other hand, the hot melt adhesives of Patent Documents 1 and 2 have a low rosin ester content and a strong odor, so that the load imposed on the environment cannot be lightened. In addition, the adhesive force to members of disposable products is also insufficient. In particular, the hot melt adhesive of Document 2 has a high viscosity, and is not suitable for spray coating.

### PRIOR ART DOCUMENTS

### Patent Documents

[Patent Document 1] JP 2017-186487 A
[Patent Document 2] JP 2018-058940 A

### SUMMARY OF INVENTION

### Problems to be Solved by the Invention

It is an object of the present invention to provide a hot melt adhesive having excellent coatability and adhesiveness to a member of a disposable product, excellent storage stability, and both having high natural resin use ratio and low odor; and a disposable product obtained by using the hot melt adhesive.

### Means for Solving the Problem

The present invention and preferred embodiments of the present invention are as follows.
1. A hot melt adhesive comprising (A) a thermoplastic block copolymer which is a copolymer of vinyl-type aromatic hydrocarbons and conjugated diene compounds, (B) a tackifying resin and (C) a wax, wherein
   the tackifying resin (B) comprises (B1) a natural resin having an acid value of 20 mg KOH/g or less.
2. The hot melt adhesive according to the above 1, wherein the natural resin (B1) has a softening point of 90° C. or more.
3. The hot melt adhesive according to the above 1 or 2, wherein the natural resin (B1) comprises a rosin ester.
4. The hot melt adhesive according to any one of the above 1 to 3, wherein the natural resin having an acid value of 20 mg KOH/g or less (B1) is contained in an amount of 20 parts by mass or more based on 100 parts by mass of the total amount of the component (A), the component (B), and the component (C).
5. The hot melt adhesive according to any one of the above 1 to 4, wherein the wax (C) comprises (C1) a wax having a melting point of 60 to 120° C.
6. The hot melt adhesive according to the above 5, wherein (C1) the wax comprises a Fischer-Tropsch wax.
7. The hot melt adhesive according to the above 5 or 6, wherein the wax having a melting point of 60 to 120° C. (C1) is contained in an amount of 1 to 10 parts by mass based on 100 parts by mass of the total amount of the component (A), the component (B) and the component (C).
8. A disposable product having the hot melt adhesive according to any one of the above 1 to 7.

### Effect of the Invention

According to the present invention, a hot melt adhesive having excellent coatability and adhesiveness to a member of a disposable product, excellent storage stability, and both having high natural resin use ratio and low odor is provided. The hot melt adhesive of the present invention is suitable for the application of producing disposable products. By using the hot melt adhesive of the present invention, a disposable product having a low impact on the environment may be produced.

### EMBODIMENTS OF THE INVENTION

The hot melt adhesive of the present invention contains (A) a thermoplastic block copolymer, (B) a tackifying resin and (C) a wax.

### <(A) Thermoplastic Block Copolymer>

In the hot melt adhesive of the present invention, the thermoplastic block copolymer (A) is a copolymer in which vinyl-type aromatic hydrocarbons and conjugated diene compounds are block-copolymerized. The thermoplastic block copolymer (A) is usually a resin composition containing a copolymer having a vinyl-type aromatic hydrocarbon block and a conjugated diene compound block.

Here, the “vinyl-type aromatic hydrocarbon” means an aromatic hydrocarbon compound having a vinyl group. Specific example thereof may include, for example, styrene, o-methylstyrene, p-methylstyrene, p-tert-butylstyrene, 1,3-dimethylstyrene, α-methylstyrene, vinylnaphthalene, vinylanthracene and the like. The most preferred among these is styrene. These vinyl-type aromatic hydrocarbons may be used alone or in combination.

The “conjugated diene compound” means a diolefin compound having at least a pair of conjugated double bonds. Specific example thereof may include, for example, 1,3-butadiene, 2-methyl-1,3-butadiene (or isoprene), 2,3-dimethyl-1,3-butadiene, 1,3-pentaziene and 1,3-hexadiene. The preferred among these are 1,3-butadiene and 2-methyl-1,3-butadiene. These conjugated diene compounds may be used alone or in combination.

The thermoplastic block copolymer (A) according to the present invention may be an unhydrogenated product or a hydrogenated product.

Examples of “the unhydrogenated product of the thermoplastic block copolymer (A)” may include, specifically, those in which a block based on conjugated diene compounds is not hydrogenated. Examples of “the hydrogenated product of the thermoplastic block copolymer (A)” may include, specifically, a block copolymer to which all or part of a block based on conjugated diene compounds is hydrogenated.

The hydrogenated ratio of “the hydrogenated product of the thermoplastic block copolymer (A)” may be indicated by the “hydrogenation ratio”. The “hydrogenation ratio” of “the hydrogenated product of the thermoplastic block copolymer (A)” means the ratio of the double bonds having been converted to saturated hydrocarbon bonds by hydrogenation, based on the total aliphatic double bonds contained in the blocks derived from the conjugated diene compounds. This “hydrogenation ratio” may be measured by an infrared spectrophotometer, a nuclear magnetic resonance apparatus, or the like.

Examples of “the unhydrogenated product of the thermoplastic block copolymer (A)” may include, specifically, a styrene-isoprene block copolymer (also referred to as “SIS”) and a styrene-butadiene block copolymer (also referred to as “SBS”). Examples of “the hydrogenated product of the thermoplastic block copolymer (A)” include, specifically, a hydrogenated styrene-isoprene block copolymer (also referred to as “SEPS”) and a hydrogenated styrene-butadiene block copolymer (also referred to as “SEBS”).

On condition that the object of the present invention is achieved, structure of the thermoplastic block copolymer (A) may be a linear type or a radial type.

The “linear type” means a linear structure. The linear type styrene block copolymer is a linear copolymer in which a styrene block and a conjugated diene block are bonded.

The radial type styrene block copolymer is a branched styrene block copolymer having a structure in which a plurality of linear type styrene block copolymers project radially around a coupling agent.

The specific structure of the radial styrene block copolymer is shown below.

[Chemical Formula 1]

(S-E)nY (1)

In the formula, n is an integer of 2 or more, S is a styrene block, E is a conjugated diene compound block, and Y is a coupling agent. n is preferably 3 or 4, and n is particularly preferably 3. Butadiene or isoprene is preferred as the conjugated diene compound.

The styrene block copolymer is a resin composition and contains the styrene-conjugated diene block copolymer represented by formula (2) in a certain ratio.

[Chemical Formula 2]

S-E (2)

In the formula, S and E have the same meaning as above. The styrene-conjugated diene block copolymer represented by formula (2) is sometimes referred to as a “diblock”.

The coupling agent is a polyfunctional compound that radially bonds linear styrene block copolymers. The type of coupling agent is not particularly limited.

Examples of the coupling agent include silane compounds such as halogenated silanes and alkoxysilanes; tin compounds such as tin halides; polycarboxylate esters; epoxy compounds such as epoxidized soybean oils; acrylates such as pentaerythritol tetraacrylate; epoxysilanes; divinyl compounds such as divinylbenzene; and the like. Specific examples include trichlorosilane, tribromosilane, tetrachlorosilane, tetrabromosilane, methyltrimethoxysilane, ethyltrimethoxysilane, vinyltrimethoxysilane, vinyltriethoxysilane, tetramethoxysilane, tetraethoxysilane, tetrachlorotin, diethyladipate and the like.

Commercially available products may be used as the component (A). Examples of the commercially available products include
Quintac 3390 (trade name), Quintac 3270 (trade name), and Quintac 3620 (trade name) manufactured by ZEON CORPORATION;
LCY5562 (trade name), and LCY3545 (trade name) manufactured by LCY GRIT CORPORATION;
Taipol 4270, and VECTOR 4213NS manufactured by TSRC Corporation;
JH8291 (trade name), JH8151 (trade name), and JH8161 (trade name) manufactured by Jinhai Chemical Corporation;
Asaprene T432 (trade name), and Asaprene T436 (trade name) manufactured by Asahi Kasei Corporation;
Kraton D1161 manufactured by Kraton Corporation; and the like.

### <(B) Tackifying Resin>

The tackifying resin refers to general resins that may impart tackiness to thermoplastic block copolymers. For example, rosin-type, terpene-type, petroleum resin-type, and coumarone resin-type resins may be used as the tackifying resin. In the hot melt adhesive of the present invention, the tackifying resin (B) contains a natural resin, and the natural resin has an acid value of 20 mg KOH/g or less. In the present specification, the natural resin refers to a tackifying resin composed of a natural resin. In the present specification, the natural resin having an acid value of 20 or less is sometimes referred to as “(B1) a natural resin”.
the natural resin (B1) may maintain the cohesive force of the hot melt adhesive, impart moderate tack to thereby improve the adhesiveness of the hot melt adhesive, and reduce the odor.

By reducing the acid value of the tackifying resin to 20 or less, the amount of volatile components decrease. As a result, by containing the natural resin (B1), the amount of volatile components also decreases in the hot melt adhesive of the present invention, so that odor generation can be suppressed. The acid value of the natural resin (B1) is preferably 15 mg KOH/g or less, and more preferably 10 mg KOH/g or less.

The natural resin (B1) is contained in an amount of 20 parts by mass or more, preferably 30 to 100 parts by mass, more preferably 50 to 100 parts by mass, and most preferably 100 parts by mass based on 100 parts by mass of the tackifying resin (B).

In the present specification, the “natural resin” refers to a modified composition of resinous substances secreted by the physiological or pathological action of animals and plants, or extracted from those tissues, or a modified product of the extracted resinous substance. The natural resin (B1) is classified generally into a rosin type and a terpene type.

The rosin type includes rosin and rosin derivatives (hydrogenated rosins, rosin esters, disproportionated rosins, polymerized rosins, maleated rosins, maleic acid-modified rosin resins, and rosin-modified phenolic resins).

The terpene type includes terpene resins, terpene-modified phenolic resins, aromatic-modified terpene resins, and hydrogenated terpene resins.

The natural resin (B1) preferably has a biomass degree of 50% or more, more preferably 65% or more, and most preferably 80% or more.

The biomass degree of the component (B1) is in the above range, and thereby, the hot melt adhesive of the present invention has an increased biomass degree, which is preferable to the environment.

In the present specification, the “biomass degree” is a value calculated by measuring the content of carbon C14 contained only in a biological substance, and is measured by an accelerator mass spectrometer (AMS). C14 is not included in fossil resources such as oil and coal. By calculating the C14 content of the target substance (component (B1)), the biomass degree of the component (B1) can be calculated, and based on the biomass degree of the component (B1), it can be calculated the biomass degree of the entire hot melt adhesive.

As the natural resin (B1), commercially available products may be used. The commercially available products include
rosin esters such as SYLVALITE 9100 (trade name), SYLVALITE 9000 (trade name), SYLVALITE RE100L (trade name), and SYLVALITE 2115 (trade name) manufactured by Kraton Corporation, KE100L (trade name) manufactured by Guangdong KOMO Corporation, Pine Crystal KE100 (trade name), and Pine Crystal KE311 (trade name) manufactured by Arakawa Chemical Industries, Ltd.); and
terpene resins such as SYLVARES TRM1115 (trade name), and SYLVARES 6110 (trade name) manufactured by Kraton Corporation.

In the present invention, the natural resin (B1) preferably contains a rosin ester. By containing a rosin ester, the hot melt adhesive of the present invention has more improved coating suitability and adhesiveness, and thus can reduce the odor, which is preferred for use in disposable products.

In the present invention, the tackifying resin (B) may contain the petroleum resin (B2). When the tackifying resin (B) contains the petroleum resin (B2), the hot melt adhesive has improved storage stability.

In the present specification, the “petroleum resin” means a synthetic resin produced by polymerizing an unsaturated petroleum fraction. A highly unsaturated C5 fraction produced as a by-product by naphtha cracking, and the like are employed as main raw materials. The raw materials are then polymerized with Friedel-Crafts catalyst to obtain the petroleum resin.

The petroleum resin (B2) is classified generally into an aliphatic type, an aromatic type, a copolymer type, a hydrogenated type and the like. The aliphatic type petroleum resin is a resin made from a C5 fraction of naphtha cracked oil. The aromatic type petroleum resin is a resin made from a C9 fraction of naphtha cracked oil. The copolymer type petroleum resin is made from a copolymer resin of C5-C9 fractions having both properties of the aliphatic type petroleum resin and the aromatic type petroleum resin. The hydrogenated petroleum resin is obtained by hydrogenating an aromatic petroleum resin or a dicyclopentadiene-based polymerized resin.

Commercially available products of (B2) the petroleum resin include T-Rez HA103 (trade name), T-Rez HB125 (trade name), and T-Rez HC103 (trade name) manufactured by ENEOS CORPORATION, HD1120 (trade name), and HD1100 (trade name) manufactured by Zibo Luhua Hongjin New Material Corporation, ECR5600 (trade name) manufactured by Exxon Mobil Corporation, Eastotac H130 (trade name), and Plastolyn 290LV (trade name) manufactured by Eastman Corporation, SUKOREZ SU420 (trade name), and SUKOREZ SU400 (trade name) manufactured by KOLON Industries, Inc., Imarve S100 (trade name), and Imarve P125 (trade name) manufactured by Idemitsu Kosan Co., Ltd., Alcon M100 (trade name), and Alcon P115 (trade name) manufactured by Arakawa Chemical Industries, Ltd. and the like.

In the hot melt adhesive of the present invention, based on 100 parts by mass of the total amount of the components (A) to (C), the component (B), in a preferred embodiment, the natural resin (B1) is contained in an amount of preferably 20 to 95 parts by mass, more preferably 50 to 90 parts by mass, and still more preferably 60 to 80 parts by mass. When the combination amount of the component (B) or the natural resin (B1) is in the above range, the hot melt adhesive of the present application has improved adhesiveness to a member of a disposable product.

### <(C) Wax>

In the present specification, the wax (C) refers to an organic substance that is solid at room temperature and becomes liquid when heated, and is generally considered a “wax”. The type of wax is not particularly limited on condition that it has wax-like properties, and it provides the hot melt adhesive of the present invention. The waxes generally have a weight-average molecular weight of less than 10000.

The hot melt adhesive of the present invention contains the wax (C), and thereby, cold flow is suppressed, storage stability is improved, and dynamic viscosity after coating is increased, thus resulting in that diffusion and volatilization of volatile components is suppressed to reduce odor.

The wax (C) may be modified with a polar functional group and the like on condition that it has commonly been employed in hot melt adhesives, and it provides the hot melt adhesive of the present invention.

Specific examples of the wax (C) may include synthetic types such as Fischer-Tropsch waxes and polyolefin waxes (polyethylene waxes, polypropylene waxes); petroleum waxes such as paraffin waxes and microcrystalline waxes; natural waxes such as castor waxes; and the like.

In the present invention, as the wax (C), a Fischer-Tropsch wax is preferably included. The Fischer-Tropsch wax refers to those which are synthesized by the Fischer-Tropsch method, and generally regarded as a Fischer-Tropsch wax (including acid-modified products). The Fischer-Tropsch wax is a wax fractionated such that its component molecules have a narrow carbon number distribution from a wax having a relatively broad carbon number distribution. When the wax (C) contains the Fischer-Tropsch wax, the balance between the solidification speed and the initial cohesive force of the hot melt adhesive after coating may further be improved.

The wax (C) preferably includes a wax having a melting point of 60 to 120° C. In the present specification, the wax having a melting point of 60 to 120° C. is sometimes referred to as “(C1) a wax. The melting point of the wax (C1) is preferably from 70 to 110° C., and more preferably from 75 to 105° C. The wax (C1) may reduce the odor while improving the coating suitability of hot melt adhesive. When the melting point of the Fischer-Tropsch wax is between 6° and 120° C., the coating suitability of the hot melt adhesive is further improved and the odor is reduced.

The wax (C1) is contained in an amount of preferably from 30 to 100 parts by mass, more preferably from 50 to 100 parts by mass, and most preferably 100 parts by mass based on 100 parts by mass of the wax (C).

In the present invention, the wax (C) may contain (C2) a wax having a melting point exceeding 120° C. When the wax (C) contains the wax (C2), the storage stability of the hot melt adhesive is improved.

Examples of typical Fischer-Tropsch waxes may include Sasol H1 (trade name), Sasol H8 (trade name), Sasol H105 (trade name), and Sasol C80 (trade name), which are all commercially available from Sasol Wax Corporation.

Examples of commercially available paraffin waxes include Paraffin Wax-150 (trade name) and Paraffin Wax-155 (trade name) manufactured by NIPPON SEIRO CO., LTD. One type of wax (C) may be used alone or two or more types may be used in combination.

Examples of commercially available products of microstalline waxes include Hi-Mic 2095 (trade name), Hi-Mic 1080 (trade name), and Hi-Mic 1090 (trade name) manufactured by NIPPON SEIRO CO., LTD.

In the hot melt adhesive of the present invention, the component (C), in a preferred embodiment, the wax (C1) is contained in an amount of preferably 1 to 10 parts by mass, more preferably 3 to 8 parts by mass, and still more preferably 4 to 6 parts by mass) based on 100 parts by mass of the total amount of the components (A) to (C). When the combination amount of the component (C) or (C1) is in the above range, the hot melt adhesive of the present application has improved storage stability and reduced odor.

### <(D) Plasticizer>

The hot melt adhesive of the present invention preferably contains (D) a plasticizer in addition to the component (A), the component (B) and the component (C). The plasticizer is combined for the purpose of lowering melt viscosity of the hot melt adhesive, imparting flexibility and improving wetting property to the adherend, and thereby, coatability of the hot melt adhesive is improved. Examples of the plasticizer (D) may include, for example, a paraffinic oil, a naphthenic oil and an aromatic oil. The plasticizer (D) is contained in the hot melt adhesive in an amount of 40 parts by mass or less, and more preferably 30 parts by mass or less based on 100 parts by mass of the total amount of the components (A) to (C).

When the amount of the plasticizer is in the above range, adhesive force of the hot melt adhesive of the present invention is further improved.

Commercially available products may be used as the plasticizer. Specific examples thereof may include, for example, White Oil Broom 350 (trade name) manufactured by Kukdong Oil & Chem, Diana Fresia S32 (trade name), Diana Process Oil PW-90 (trade name), and DN Oil KP-68 (trade name) manufactured by Idemitsu Kosan Co., Ltd., Enerper M1930 (trade name) manufactured by BP Chemicals, Kaydol (trade name) manufactured by Crompton Limited, Primol 352 (trade name) manufactured by ESSO CORPORATION, Process Oil NS100 manufactured by Idemitsu Kosan Co., Ltd., and KN4010 (trade name) manufactured by PetroChina Company Limited. These plasticizers may be used alone or in combination.

The hot melt adhesive according to the present invention may further contain various additives as necessary. Examples of such various additives may include, for example, stabilizers and fine particle fillers.

A stabilizer is combined in order to prevent decreasing of molecular weight, gelation, coloring, generation of odor and the like of the hot melt adhesive due to heat, and thereby, stability of the hot melt adhesive is improved. The type of stabilizer is not particularly limited on condition that it provides the hot melt adhesive of the present invention. Examples of the “stabilizer” may include, for example, antioxidants and ultraviolet absorbers.

An ultraviolet absorber is used to improve the light resistance of the hot melt adhesive. The “antioxidant” is used to prevent oxidative deterioration of the hot melt adhesive. The type of antioxidant or ultraviolet absorber is not particularly limited on condition that it has been employed for disposable products, and it provides the disposable products as described below.

Examples of the antioxidant may include, for example, phenolic antioxidants, sulfur antioxidants, and phosphoric antioxidants. Examples of the ultraviolet absorber may include, for example, benzotriazole-type ultraviolet absorbers and benzophenone-type ultraviolet absorbers. Furthermore, lactone-based stabilizers may also be added. These stabilizers may be used alone or in combination.

Commercially available products may be used as the stabilizer. Examples thereof may include, for example, SUMILIZER GM (trade name), SUMILIZER TPD (trade name) and SUMILIZER TPS (trade name) manufactured by SUMITOMO CHEMICAL COMPANY, LIMITED, Irganox 1010 (trade name), Irganox HP2225FF (trade name), Irgafos 168 (trade name) and Irganox 1520 (trade name) manufactured by Ciba Specialty Chemicals Co., and JF77 (trade name) manufactured by JOHOKU CHEMICAL CO., LTD. These stabilizers may be used alone or in combination.

The hot melt adhesive of the present invention is produced by formulating the above components in a predetermined ratio, further formulating various additives as necessary, heating, melting and mixing them. Specifically, it is produced by putting the above-mentioned components into a melting and mixing kettle equipped with a stirrer, and heating and mixing them.

The obtained hot melt adhesive has a melt viscosity at 150° C. of preferably less than 7000 mPa second, more preferably less than 5000 mPa second, and still more preferably less than 2000 mPa second. The “melt viscosity” means the viscosity in molten state of the hot melt adhesive. The melt viscosity is measured with a Brookfield RVT type viscometer (spindle No. 27) in accordance with the method B described in JA17-1991.

A disposable product is produced using members such as a polyethylene film and a thin nonwoven fabric. Considering the heat resisting temperature of these members of the disposable product, the melt viscosity at 150° C. is measured as the coating temperature at which they do not shrink or break. As melt viscosity of the hot melt adhesive is low, it becomes easy to coat, and therefore, the melt viscosity may be used as an index of coating suitability.

When the melt viscosity of the hot melt adhesive is less than 5000 mPa second, spray coating or intermittent coating may be performed on the member of the disposable product easily and uniformly. When the melt viscosity of the hot melt adhesive is 5000 mPa second to 7000 mPa second, spray coating and intermittent coating may be performed on the member of the disposable product. On the other hand, when the melt viscosity of the hot melt adhesive exceeds 7000 mPa second, it becomes difficult to perform intermittent coating on the member of the disposable product.

The hot melt adhesive has a softening point of preferably higher than 30° C., more preferably higher than 70° C., and still more preferably higher than 80° C. The softening point of the hot the melt adhesive is measured based on the ring & ball method (method defined in the Japan Adhesive Industry Association standard JAI-7-1999).

As softening point of the hot melt adhesive is high, the cold flow phenomenon is less likely to occur, and therefore, the softening point may be used as an index of storage stability.

The hot melt adhesive according to the present invention is widely used for paper processing, bookbinding, disposable products and the like, but is mainly used for disposable products. The type of “disposable product” is not particularly limited as long as it is a so-called sanitary material, for example. Specific examples of the sanitary material may include disposable diapers, sanitary napkins, pet sheets, hospital gowns, and surgical lab coats and the like.

In another aspect, the present invention provides a disposable product obtained by applying the above-mentioned hot melt adhesive. The disposable product is composed by bonding with using the hot melt adhesive according to the present invention at least one member selected from the group consisting of woven fabric, nonwoven fabric, rubber, resin and paper, and a polyolefin film. As the polyolefin film, polyethylene film is preferred because of its durability and cost.

In a disposable product manufacturing line, a hot melt adhesive is generally applied to at least one of various members (for example, nonwoven fabric and the like) of a disposable product and a polyolefin film, and the film and the member are bonded with pressure to manufacture a disposable product. At the time of application, the hot melt adhesive may be squirted from various squirts and used.

In the present invention, the coating may be either contact coating or non-contact coating.

“Contact coating” is a coating method in which an ejector is brought into contact with a member or a film when a hot melt adhesive is applied. Specific examples thereof include V-slit coating.

“Non-contact coating” is a coating method in which the ejector is not brought into contact with a member or a film when a hot melt adhesive is applied. Specific examples of the non-contact coating methods may include, for example, spiral coating that may be applied in a spiral shape, omega coating and control seam coating that may be applied in a wavy shape, slot spray coating and curtain spray coating that may be applied in a planar shape, dot coating that may be applied in a dot form and the like.

### EXAMPLES

The present invention will be described more specifically and in detail by examples and comparative examples. These examples are only embodiments of the present invention, and the present invention is not limited in any way to these examples. In the description of the examples, unless otherwise stated, the components excluding solvents are based on parts by mass and percent by mass.

### 1. Production of Hot Melt Adhesives

The components used in the present examples are shown below.

### (A) Thermoplastic Block Copolymer

(A1) Styrene-isoprene-styrene block copolymer (styrene 15% by mass, melt index 11, JH SIS 8161 (trade name) manufactured by Chengngbningbo Jinhai Chenguang Corporation)
(A2) Styrene-isoprene-styrene block copolymer (styrene 15% by mass, melt index 10, JH SIS 8151 (trade name) manufactured by Chengngbningbo Jinhai Chenguang Corporation)
(A3) Styrene-butadiene-styrene block copolymer (styrene 35% by mass, 15% toluene viscosity 46 mPa second, Asaprene T438 (trade name) manufactured by Asahi Kasei Chemicals Corporation)
(A4) Styrene-butadiene-styrene block copolymer (styrene 40% by mass, melt index 4, Tufprene T125 (trade name) manufactured by Asahi Kasei Chemicals Corporation)

### (B) Tackifying Resin

(B1) Natural resin having an acid value of 20 mg KOH/g or less
(B1-1) Rosin ester (acid value 10 mg KOH/g, softening point 104° C., SYLVALITE 9100 (trade name) manufactured by Kraton Corporation)
(B1-2) Rosin ester (acid value 8 mg KOH/g, softening point 102° C., SYLVALITE 9000 (trade name) manufactured by Kraton Corporation)
(B1-3) Rosin ester (acid value 15 mg KOH/g, softening point 98° C., SYLVALITE RE100L (trade name) manufactured by Kraton Corporation)
(B1-4) Rosin ester (acid value 9 mg KOH/g, softening point 114° C., SYLVALITE 2115 (trade name) manufactured by Kraton Corporation)
(B1-5) Terpene resin (acid value 0 mg KOH/g, softening point 100° C., CLEARON K100 (trade name) manufactured by YASUHARA CHEMICAL CO., LTD.
(B1′) Natural resin having an acid value of more than 20 mg KOH/g
(B1′-6) Rosin ester (acid value 22 mg KOH/g, softening point 29° C., SYLVALITE RE25 (trade name) manufactured by Kraton Corporation)
(B1′-7) Rosin ester (acid value 170 mg KOH/g, softening point 78° C., RHR 101 HK (trade name) manufactured by Wuzhou Sun Shine Forestry & Chemicals Co., Ltd.) (B2) Petroleum resin
(B2-1) Hydrogenated petroleum-based resin (softening point 103° C., T-REZ HA103 (trade name) manufactured by ENEOS CORPORATION)
(B2-2) Hydrogenated petroleum-based resin (50° C. viscosity at 3000 mPa second, Rigalite R1010 (trade name) manufactured by Eastman Chemical Company)
(B2-3) Acid-modified petroleum-based resin (acid value 2 mg KOH/g, softening point 96° C., Quinton CX495 (trade name) manufactured by ZEON Corporation)

### (C) Wax

(C1) Wax having a melting point of 60 to 120° C.
(C1-1) Fischer-Tropsch wax (melting point 101° C., Sasol Wax H1 (trade name) manufactured by Sasol Corporation)
(C1-2) Fischer-Tropsch wax (melting point 75° C., Sasol wax C80 (trade name) manufactured by Sasol Corporation)
(C2) Polyethylene Wax (melting point 126° C., High Wax 400P (trade name) manufactured by Mitsui Chemicals, Inc.)

### (D) Plasticizers

(D1) Paraffin oil (Daphne Oil KP-68 (trade name) manufactured by Idemitsu Kosan Co., Ltd.)
(D2) Naphthene oil (KN4010 (trade name) manufactured by PetroChina Company Limited)

### (E) Stabilizers

(E1) Hindered phenol antioxidant (Adekastab AO-60 manufactured by ADEKA CORPORATION)

The hot melt adhesives were prepared by combining and stirring to mix above components in predetermined ratios as shown in Tables 1 and 2.

Specifically, the respective components were placed in a 225 ml container, heated to 160° C. with a glas-col heater, and the formulation of the respective components was stirred for 20 minutes at a stirring speed of 300 to 500 rpm using a stirrer. All numerical values for the compositions of the hot melt adhesives in the examples and comparative examples disclosed in Tables 1 and 2 are parts by mass (solid content).

TABLE 1

| | | Example | | | | | | |
|---|---|---|---|---|---|---|---|---|
| | | 1 | 2 | 3 | 4 | 5 | 6 | 7 |
| (A) Thermoplastic block copolymer | | | | | | | | |
| (A1) | SIS, styrene 15% by | 20 | 13 | 26 | 11 | | 12 | 11 |
| | weight, MI 11 (JH | | | | | | | |
| | SIS 8161) | | | | | | | |
| (A2) | SIS, styrene 15% by | | 13 | | 12 | | 8 | |
| | weight, MI 10 (JH | | | | | | | |
| | SIS 8151) | | | | | | | |
| (A3) | SBS, styrene 35% by | | | | | 24 | | |
| | weight, 15% toluene | | | | | | | |
| | viscosity 46 mPas | | | | | | | |
| | (Asaprene T438) | | | | | | | |
| (A4) | SBS, styrene 40% by | | | | | | | 11 |
| | weight, MI 4 | | | | | | | |
| | (Tufprene T125) | | | | | | | |
| (B) Tackifying resin | | | | | | | | |
| (B1) Natural resin having an acid | | | | | | | | |
| value of 20 mg KOH/g or less | | | | | | | | |
| (B1-1) | Rosin ester, acid | 76 | 70 | 70 | | | | |
| | value 10, softening | | | | | | | |
| | point 104° C. | | | | | | | |
| | (SYLVALITE 9100) | | | | | | | |
| (B1-2) | Rosin ester, acid | | | | 70 | | | |
| | value 8, softening | | | | | | | |
| | point 102° C. | | | | | | | |
| | (SYLVALITE 9000) | | | | | | | |
| (B1-3) | Rosin ester, acid | | | | | | | 30 |
| | value 15, softening | | | | | | | |
| | point 98° C. | | | | | | | |
| | (SYLVALITE | | | | | | | |
| | RE100L) | | | | | | | |
| (B1-4) | Rosin ester, acid | | | | | 29 | | |
| | value 9, softening | | | | | | | |
| | point 114° C. | | | | | | | |
| | (SYLVALITE 2115) | | | | | | | |
| (B1-5) | Terpene resin, acid | | | | | | 79 | |
| | value 0, softening | | | | | | | |
| | point 100° C. | | | | | | | |
| | (CLEARON K100) | | | | | | | |
| (B2) Petroleum resin | | | | | | | | |
| (B2-1) | Hydrogenated | | | | | 44 | | 44 |
| | petroleum resin, | | | | | | | |
| | softening point 103° C. | | | | | | | |
| | (T-REZ HA 103) | | | | | | | |
| (B2-2) | Hydrogenated | | | | | | | |
| | petroleum resin, | | | | | | | |
| | viscosity 3000 | | | | | | | |
| | mPas(50° C.) (Rigalite | | | | | | | |
| | R1010) | | | | | | | |
| (C)Wax | | | | | | | | |
| (C1)Wax having a melting | | | | | | | | |
| point of 60 to 120° C. | | | | | | | | |
| (C1-1) | Fischer-Tropsch | 4 | 4 | 4 | | 3 | | |
| | wax, melting point | | | | | | | |
| | 101° C. (Sasol Wax | | | | | | | |
| | H1) | | | | | | | |
| (C1-2) | Fischer-Tropsch | | | | 7 | | 1 | 4 |
| | wax, melting point | | | | | | | |
| | 75° C. (Sasol Wax | | | | | | | |
| | C80) | | | | | | | |
| (C2) | Polyethylene Wax, | | | | | | | |
| | melting point 126° C., | | | | | | | |
| | (High Wax 400P) | | | | | | | |
| (D)Plasticizer | | | | | | | | |
| (D1) | Paraffin oil (Daphne | 24 | 24 | 24 | 23 | 40 | 24 | 40 |
| | Oil KP-68) | | | | | | | |
| (D2) | Naphthene oil | | | | | | | |
| | (KN4010) | | | | | | | |
| (E)Stabilizer | | | | | | | | |
| (E1) | Hindered Phenol | 1 | 1 | 1 | 1 | 1 | 1 | 1 |
| | Antioxidant | | | | | | | |
| | (Adekastab AO-60) | | | | | | | |

| | | | | | | | |
|---|---|---|---|---|---|---|---|
| Total main components (ABC) | 100 | 100 | 100 | 100 | 100 | 100 | 100 |
| Total formulation | 125 | 125 | 125 | 124 | 141 | 125 | 141 |

TABLE 2

| | | Example | | | | | |
|---|---|---|---|---|---|---|---|
| | | 8 | 9 | 10 | 11 | 12 | 13 |
| (A) Thermoplastic block copolymer | | | | | | | |
| (A1) | SIS, styrene 15% by | 8 | | 8 | | 10 | |
| | weight, MI 11 (JH | | | | | | |
| | SIS 8161) | | | | | | |
| (A2) | SIS, styrene 15% by | 16 | | | | 10 | |
| | weight, MI 10 (JH | | | | | | |
| | SIS 8151) | | | | | | |
| (A3) | SBS, styrene 35% by | | 32 | 21 | 12 | | 27 |
| | weight, 15% toluene | | | | | | |
| | viscosity 46 mPas | | | | | | |
| | (Asaprene T438) | | | | | | |
| (A4) | SBS, styrene 40% by | | | | 8 | | |
| | weight, MI 4 | | | | | | |
| | (Tufprene T125) | | | | | | |
| (B) Tackifying resin | | | | | | | |
| (B1) Natural resin having an acid | | | | | | | |
| value of 20 mg KOH/g or less | | | | | | | |
| (B1-1) | Rosin ester, acid | 70 | 63 | 32 | 70 | 50 | |
| | value 10, softening | | | | | | |
| | point 104° C. | | | | | | |
| | (SYLVALITE 9100) | | | | | | |
| (B1-2) | Rosin ester, acid | | | | | | |
| | value 8, softening | | | | | | |
| | point 102° C. | | | | | | |
| | (SYLVALITE 9000) | | | | | | |
| (B1-3) | Rosin ester, acid | | | | | | |
| | value 15, softening | | | | | | |
| | point 98° C. | | | | | | |
| | (SYLVALITE | | | | | | |
| | RE100L) | | | | | | |
| (B1-4) | Rosin ester, acid | | | | | | 23 |
| | value 9, softening | | | | | | |
| | point 114° C. | | | | | | |
| | (SYLVALITE 2115) | | | | | | |
| (B1-5) | Terpene resin, acid | | | | | 29 | |
| | value 0, softening | | | | | | |
| | point 100° C. | | | | | | |
| | (CLEARON K100) | | | | | | |
| (B2) Petroleum resin | | | | | | | |
| (B2-1) | Hydrogenated | | | 29 | | | |
| | petroleum resin, | | | | | | |
| | softening point 103° C. | | | | | | |
| | (T-REZ HA 103) | | | | | | |
| (B2-2) | Hydrogenated | | | | | | 44 |
| | petroleum resin, | | | | | | |
| | viscosity | | | | | | |
| | 3000 mPas(50° C.) | | | | | | |
| | (Rigalite R1010) | | | | | | |
| (C) Wax | | | | | | | |
| (C1) Wax having a melting | | | | | | | |
| point of 60 to 120° C. | | | | | | | |
| (C1-1) | Fischer-Tropsch | 6 | | | | | |
| | wax, melting point | | | | | | |
| | 101° C. (Sasol Wax | | | | | | |
| | H1) | | | | | | |
| (C1-2) | Fischer-Tropsch | | | 10 | 10 | | 6 |
| | wax, melting point | | | | | | |
| | 75° C. (Sasol Wax | | | | | | |
| | C80) | | | | | | |
| (C2) | Polyethylene Wax, | | 5 | | | 1 | |
| | melting point 126° C., | | | | | | |
| | (High Wax 400P) | | | | | | |
| (D) Plasticizer | | | | | | | |
| (D1) | Paraffin oil (Daphne | | | | | | |
| | Oil KP-68) | | | | | | |
| (D2) | Naphthene oil | 24 | 20 | 40 | 30 | 20 | |
| | (KN4010) | | | | | | |
| (E) Stabilizer | | | | | | | |
| (E1) | Hindered Phenol | 2 | 1 | 1 | | 1 | 1 |
| | Antioxidant | | | | | | |
| | (Adekastab AO-60) | | | | | | |

| | | | | | | |
|---|---|---|---|---|---|---|
| Total main components (ABC) | 100 | 100 | 100 | 100 | 100 | 100 |
| Total formulation | 126 | 121 | 141 | 130 | 121 | 101 |

TABLE 3

| | | Comparative Example | | | |
|---|---|---|---|---|---|
| | | 1 | 2 | 3 | 4 |
| (A) Thermoplastic block copolymer | | | | | |
| (A1) | SIS, styrene 15% by | 20 | 20 | 20 | 20 |
| | weight, MI 11 (JH SIS | | | | |
| | 8161) | | | | |
| (B) Tackifying resin | | | | | |
| (B1) Natural resin having an acid | | | | | |
| value of 20 mg KOH/g or less | | | | | |
| (B1-1) | Rosin ester, acid value | | | 80 | |
| | 10, softening point | | | | |
| | 104° C. (SYLVALITE | | | | |
| | 9100) | | | | |
| (B1′) Natural resin having an acid | | | | | |
| value of more than 20 mg KOH/g | | | | | |
| (B1′-6) | Rosin ester, acid value | 76 | | | |
| | 22, softening point | | | | |
| | 29° C. (SYLVALITE | | | | |
| | RE25) | | | | |
| (B1′-7) | Rosin ester, acid value | | 76 | | |
| | 170, softening point | | | | |
| | 78° C. (RHR 101HK) | | | | |
| (B2) Petroleum resin | | | | | |
| (B2-3) | Acid-modified | | | | 76 |
| | petroleum-based resin, | | | | |
| | acid value 2, softening | | | | |
| | point 96° C. (Quinton | | | | |
| | CX495) | | | | |
| (C) Wax | | | | | |
| (C1) Wax having a melting | | | | | |
| point of 60 to120° C. | | | | | |
| (C1-1) | Fischer-Tropsch wax, | 4 | 4 | | 4 |
| | melting point 101° C. | | | | |
| | (Sasol Wax H1) | | | | |
| (D) Plasticizer | | | | | |
| (D1) | Paraffin oil (Daphne | 24 | 24 | 24 | 24 |
| | Oil KP-68) | | | | |
| (E) Stabilizer | | | | | |
| (E1) | Hindered Phenol | 1 | 1 | 1 | 1 |
| | Antioxidant | | | | |
| | (Adekastab AO-60) | | | | |

| | | | | |
|---|---|---|---|---|
| Total main components (ABC) | 100 | 100 | 100 | 100 |
| Total formulation | 125 | 125 | 125 | 125 |

### 2. Performance Evaluation of Hot Melt Adhesives

With respect to the hot melt adhesives described above, the coating suitability (melt viscosity at 150° C.), storage stability (softening point), adhesive performance (peel strength), and odor were evaluated. The preparation method of a sample for evaluation, evaluation test method and evaluation criteria are described below.

### <Coating Suitability (Melt Viscosity at 150° C.)

The viscosity at 150° C. of each hot melt adhesive was measured in accordance with the method B described in JAI 7-1991. For the measurement, a Brookfield viscometer was used, and a No. 27 rotor was used. The coating suitability of the hot melt adhesive was evaluated using the following criteria to confirm the performance capable of spray coating without shrinking or breaking the members of the disposable product.
A (Excellent) . . . Melt viscosity at 150° C. is less than 2000 mPa·s
B (Good) . . . Melt viscosity at 150° C. is 2000 mPa·s or more and less than 5000 mPa·s
C (Fair) . . . Melt viscosity at 150° C. is 5000 mPa·s or more and less than 7000 mPa·s
D (Fail) . . . Melt viscosity at 150° C. is more than 7000 mPa·s

### <Storage Stability (Softening Point)>

The softening point of the hot melt adhesives was measured by the ring & ball method (method defined in the Japan Adhesive Industry Association standard JAI-7-1999). Based on the measured softening points, the storage stability of the hot melt adhesives was evaluated using the following criteria. As the softening point of hot melt adhesives increases, cold flow is less likely to occur and storage stability improves.
A (Excellent) . . . Softening point is more than 80° C.
B (Good) . . . Softening point is more than 70° C. and 80° C. or less
C (Fair) . . . Softening point is more than 30° C. and 70° C. or less
D (Fail) . . . Softening point is 30° C. or less

### <Adhesiveness (Peel Strength)>

Each hot melt adhesive was applied to a PET film having a thickness of 50 μm to form an adhesive layer having a thickness of 50 μm. This was formed to have a width of 25 mm, which served as a test sample.

On the other hand, a cotton cloth (Kanakin No. 3) for the JIS dye fastness test (in accordance with JIS L 0803) was cut into a size of 30×60 mm in the weave direction, which served as an adherend substrate.

The test sample and the adherend substrate were held at 23° C. for 30 minutes or more. They were then pasted together with a 2 kg roller at a speed of 300 mm/min. After pasting them together, they were held for 24 hours in a 23° C. environment. A 180° peel test was then conducted at a speed of 300 mm/min using a universal tensile testing machine. For each of the hot melt adhesives (the examples and comparative examples), at least three samples were measured and the average value was calculated, which served as the peel strength value. The peel strength was evaluated based on the following criteria.
A (Excellent) . . . Peel strength exceeds 1000 g/25 mm
B (Good) . . . Peel strength is higher than 500 g/25 mm and 1000 g/25 mm or less
C (Fair) . . . Peel strength is higher than 100 g/25 mm and 500 g/25 mm or less
D (Fail) . . . Peel strength is 100 g/25 mm or less

### <Odor>

### (Sensory Odor Intensity)

Fifty grams of the hot melt compositions of the examples and comparative examples served as evaluation samples. Fifty grams of each sample were placed in a 225 mL glass container, covered with an aluminum foil, and then allowed to stand in a constant temperature chamber at 23° C. for 1 hour. The aluminum foil was then removed and the odor was immediately checked. The evaluation criteria are as follows.
A (Excellent) . . . Almost no odor is detected.
B (Good) . . . A slight odor is detected.
C (Fair) . . . An obvious odor is detected, but not unpleasant.
D (Fail) . . . A strong and unpleasant odor is detected.

### (Measured Odor Intensity)

Fifty grams of the hot melt compositions of the examples and comparative examples were used as evaluation samples. Fifty grams of each sample were placed in a 225 mL glass container, covered with an aluminum foil, and allowed to stand in a constant temperature chamber at 23° C. for 1 hour. The aluminum foil was then removed and the odor intensity was measured with a portable odor sensor XP-329 IIIR. The measurements were performed in the monitor mode for 1 minute, and the peak level served as the odor intensity.
A (Excellent) . . . Odor intensity is less than 25 levels
B (Good) . . . Odor intensity is 25 levels or more and less than 30 levels
C (Fair) . . . Odor intensity is 30 levels or more and less than 35 levels
D (Fail) . . . Odor intensity is 35 levels or more

TABLE 4

| | Example | | | | | | |
|---|---|---|---|---|---|---|---|
| | 1 | 2 | 3 | 4 | 5 | 6 | 7 |
| Viscosity (mPas, | 1330 | 3838 | 1880 | 2375 | 1385 | 2465 | 1725 |
| 150° C.) | | | | | | | |
| Coating suitability | A | A | A | B | A | B | A |
| Softening point | 87 | 88 | 83 | 73 | 94 | 95 | 78 |
| (° C.) | | | | | | | |
| Storage stability | A | A | A | B | A | A | A |
| (cold flow) | | | | | | | |
| Peel strength | 1165 | 1202 | 1346 | 858 | 432 | 1058 | 440 |
| (g/25 mm) | A | A | A | B | C | A | C |
| Sensory odor intensity | A | A | A | A | A | B | B |
| Measured odor | 22 | 22 | 17 | 20 | 17 | 24 | 24 |
| intensity | A | A | A | A | A | A | A |

TABLE 5

| | Example | | | | | |
|---|---|---|---|---|---|---|
| | 8 | 9 | 10 | 11 | 12 | 13 |
| Viscosity (mPas, | 2250 | 5500 | 1690 | 550 | 2750 | 1125 |
| 150° C.) | | | | | | |
| Coating suitability | B | C | A | A | B | A |
| Softening point | 87 | 112 | 83 | 98 | 71 | 95 |
| (° C.) | | | | | | |
| Storage stability | A | A | A | A | B | A |
| (cold flow) | | | | | | |
| Peel strength | 507 | 634 | 384 | 222 | 612 | 183 |
| (g/25 mm) | B | B | C | C | B | C |
| Sensory odor intensity | A | A | A | A | B | A |
| Measured odor | 22 | 23 | 18 | 19 | 26 | 22 |
| intensity | A | A | A | A | B | A |

TABLE 6

Comparative Example

| | 1 | 2 | 3 | 4 |
|---|---|---|---|---|
| Viscosity (mPas, 150° C.) | 1120 | 1230 | 1458 | 8500 |
| Coating suitability | A | A | A | D |
| Softening point (° C.) | 23 | 87 | 62 | 99 |
| Storage stability (cold | D | A | C | A |
| flow) | | | | |
| Peel strength (g/25 mm) | 19 | 1458 | 1782 | 934 |
| | D | A | A | B |
| Sensory odor intensity | D | D | D | D |
| Measured odor intensity | 35 | 33 | 42 | 42 |
| | D | D | D | D |

As shown in Tables 4 and 5, the hot melt adhesives of Examples 1 to 13 have excellent coating suitability, storage stability, foil adhesiveness, and can suppress the generation of odor. In particular, the hot melt adhesives of Examples 1 to 3 all show A ratings.

As shown in Table 6, the hot melt adhesives in the comparative examples fail to suppress the odor generation. When it comes to the hot melt adhesive in Comparative Example 1, it has all D ratings except for coating suitability.

### INDUSTRIAL APPLICABILITY

Since the hot melt adhesives of the present invention contain natural resins such as rosin esters in large amounts, they are favorable in terms of protection of the environment and are suitable for disposable products since they can suppress the generation of odor.

1: A hot melt adhesive comprising (A) a thermoplastic block copolymer which is a copolymer of vinyl-type aromatic hydrocarbons and conjugated diene compounds, (B) a tackifying resin and (C) a wax,
wherein the tackifying resin (B) comprises (B1) a natural resin having an acid value of 20 mg KOH/g or less; and
wherein the hot melt adhesive has an odour detection level less than 30 level, when 50 g of the hot melt adhesive is placed in a 225 mL glass container with aluminium foil for 1 hour at 23° C. and measured with XP-329 IIIR immediately thereafter.

2: The hot melt adhesive according to claim 1, wherein the natural resin (B1) has a softening point of 90° C. or more.

3: The hot melt adhesive according to claim 1, wherein the natural resin (B1) comprises a rosin ester.

4: The hot melt adhesive according to claim 1, wherein the natural resin having an acid value of 20 mg KOH/g or less (B1) is contained in an amount of 20 parts by mass or more based on 100 parts by mass of the total amount of the component (A), the component (B), and the component (C).

5: The hot melt adhesive according to claim 1, wherein the wax (C) comprises (C1) a wax having a melting point of 60 to 120° C.

6: A disposable product having the hot melt adhesive according to claim 1.

7: The hot melt adhesive according to claim 1, wherein the hot melt adhesive has an odour detection level less than 25 level.

8: The hot melt adhesive according to claim 4, wherein the (B1) is contained in an amount of 10 parts by mass or more.
